(19) United States
(12) Patent Application Publication
(10) Pub. No.: US 2025/0379405 A1
(43) Pub. Date: Dec. 11, 2025

(54) CABLING HAVING FARADAY CAGES IMPLEMENTED THEREWITH

(71) Applicant: International Business Machines Corporation, Armonk, NY (US)

(72) Inventors: Brandon Purcell, San Jose, CA (US); Georg Lothar Lauhoff, San Jose, CA (US); Sassan K. Shahidi, San Jose, CA (US)

(21) Appl. No.: 18/739,086

(22) Filed: Jun. 10, 2024

(51) Int. Cl. H01R 13/6581; G11B 33/12; G11B 33/14

(52) U.S. Cl. CPC H01R 13/6581; G11B 33/122; G11B 33/1493

(57) ABSTRACT

A tape drive cable, according to one approach, includes: a connector and a bond region. The tape drive cable also includes read and write lines that that include traces and that extend from the bond region to the connector. At least one Faraday cage also surrounds the write and/or read lines on all four sides of the respective traces in the tape drive cable. Other tape drive cables, systems, methods, and computer program products are described in additional approaches.

### BACKGROUND

The present invention relates to data storage systems, and more particularly, this invention relates to cabling having Faraday cages.

In magnetic storage systems, magnetic transducers read data from and write data onto magnetic recording media. Data is written on the magnetic recording media by moving a magnetic recording transducer to a position over the media where the data is to be stored. The magnetic recording transducer then generates a magnetic field, which encodes the data into the magnetic media. Data is read from the media by similarly positioning the magnetic read transducer and then sensing the magnetic field of the magnetic media. Read and write operations may be independently synchronized with the movement of the media to ensure that the data can be read from and written to the desired location on the media.

An important and continuing goal in the data storage industry is that of increasing the density of data stored on a medium. For tape storage systems, that goal has led to increasing the track and linear bit density on recording tape, and decreasing the thickness of the magnetic tape medium. This enables fitting a longer tape into a cartridge of the same dimensions, thereby increasing its capacity. However, the development of small footprint, higher performance tape drive systems has created various challenges ranging from the design of tape head assemblies for use in such systems to dealing with tape dimensional instability. For instance, crosstalk has prevented further miniaturization of conventional magnetic head assemblies. Crosstalk primarily results from inductive and capacitive coupling between adjacent leads, which appears as noise in the readback signal. This in turn adversely affects the critical signal to noise ratio, leading to limits in data rate, increased read error rate, etc. Crosstalk between the writers and servo furthermore also worsen the tracking control thereby preventing a further increase in track density.

In an attempt to overcome the issues crosstalk poses among other challenges to write the information, conventional systems have implemented read-while-write verification, in which the just-written data is read by a trailing read transducer array to verify that the data was written correctly. Crosstalk between the writer leads and reader leads in conventional products has heretofore been believed to be so severe as to prevent the use of concurrently-active write and read transducer arrays on a single module. Moreover, this has only become more notable as data storage densities continue to increase. Accordingly, a need exists for an apparatus that eliminates or at least reduces crosstalk while allowing concurrent use of an array of read transducers and an array of write transducers in a single module.

### SUMMARY

A tape drive cable, according to one approach, includes: a connector and a bond region. The tape drive cable also includes read and write lines that that include traces and that extend from the bond region to the connector. At least one Faraday cage also surrounds the write and/or read lines on all four sides of the respective traces in the tape drive cable.

A tape drive cable, according to another approach, includes: a connector, and a bond region. The tape drive cable also includes read and write lines that that include traces and that extend from the bond region to the connector. Furthermore, Faraday cages surround each of the write lines on all four sides of the respective traces in the tape drive cable.

Any of these approaches may be implemented in a magnetic data storage system such as a tape drive system, which may include a magnetic head, a drive mechanism for passing a magnetic medium (e.g., recording tape) over the magnetic head, and a controller electrically coupled to the magnetic head.

Other aspects and approaches of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a schematic diagram of a simplified tape drive system, in accordance with one approach.

FIG. 2B is a schematic diagram of a tape cartridge, in accordance with one approach.

FIG. 2C illustrates a side view of a flat-lapped, bi-directional, two-module magnetic tape head, in accordance with one approach.

FIG. 2D is a tape bearing surface view taken from Line 2D of FIG. 2C.

FIG. 2E is a detailed view taken from Circle 2E of FIG. 2D.

FIG. 2F is a detailed view of a partial tape bearing surface of a pair of modules, in accordance with one approach.

FIG. 3 is a partial tape bearing surface view of a magnetic head having a write-read-write configuration, in accordance with one approach.

FIG. 4 is a partial tape bearing surface view of a magnetic head having a read-write-read configuration, in accordance with one approach.

FIG. 5 is a side view of a magnetic tape head with three modules where the modules all generally lie along about parallel planes, in accordance with one approach.

FIG. 6 is a side view of a magnetic tape head with three modules in a tangent (angled) configuration, in accordance with one approach.

FIG. 7 is a side view of a magnetic tape head with three modules in an overwrap configuration, in accordance with one approach.

FIGS. 8A-8C are schematics depicting the principles of tape tenting.

FIG. 9 is a representational diagram of files and indexes stored on a magnetic tape, in accordance with one approach.

FIG. 10A is a representational view of a tape drive cable, in accordance with one approach.

FIG. 10B is a partial detailed view of the bond region taken from Rectangle 10B of FIG. 10A, in accordance with one approach.

FIG. 10C is a partial cross-sectional view of the cable taken from Line 10C of FIG. 10A, in accordance with one approach.

FIG. 10D is a partial cross-sectional view of the cable taken from Line 10C of FIG. 10A, in accordance with another approach.

FIG. 10E is a partial cross-sectional view of the cable taken from Line 10C of FIG. 10A, in accordance with still another approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred approaches of magnetic storage systems, as well as operation and/or component parts thereof.

In one general approach, a tape drive cable includes: a connector and a bond region. The tape drive cable also includes read and write lines that that include traces and that extend from the bond region to the connector. At least one Faraday cage also surrounds the write and/or read lines on all four sides of the respective traces in the tape drive cable.

Approaches herein are thereby desirably able to eliminate crosstalk even in confined spaces as components continue to be miniaturized. This also allows for concurrent use of an array of read transducers and an array of write transducers in a single module. By surrounding the traces in the respective write and/or read lines on all four sides, the Faraday cages are thereby able to shield adjacent traces from experiencing any crosstalk. For example, Faraday cages may be implemented on a tape drive cable stack (e.g., flexible printed circuit (FPC) cable) and isolate read lines from the write lines on the cable stack, using a proper ground connection. With proper grounding, these Faraday cages will desirably isolate the write signals in the cable stack and stop the induction of voltage onto the neighboring reader traces.

In some implementations, the connector is configured to physically couple the traces to a controller. Moreover, the bond region is configured to enable physical coupling of the traces to electrical connections of a tape module, where each of the electrical connections corresponds to a transducer on the tape module. Faraday cages that are implemented in the approaches herein may thereby desirably provide crosstalk protection from the bond region all the way to the connector and corresponding magnetic head. Shielding the traces along virtually their whole lengths thereby improves read and write performance by allowing for tighter spacing and greater achievable storage densities.

In some implementations, the at least one Faraday cage includes Faraday cages that surround each of the respective write and read lines on all four sides of the respective traces. The Faraday cage may thereby be embedded as a top layer, a bottom layer, and side layers that extend through layers of the tape drive cable. Faraday cages that are implemented in the approaches herein may thereby desirably provide crosstalk protection for both read and write lines. Shielding the traces corresponding to the reading and writing of data thereby improves both read and write performance by allowing for tighter spacing and greater achievable storage densities.

In some implementations, the at least one Faraday cage includes Faraday cages that surround each of the respective write lines on all four sides of the respective traces. Moreover, each Faraday cage includes a plurality of electromagnetic interference (EMI) shields extending through layers of the respective write line. Accordingly, each of the EMI shields extends between adjacent pairs of write traces. Faraday cages that are implemented in the approaches herein may thereby desirably provide crosstalk protection between adjacent pairs of write traces. Shielding each adjacent pair of write traces further improves write performance by allowing for even tighter spacing and greater achievable storage densities.

In some implementations, the at least one Faraday cage includes Faraday cages that surround each of the respective write lines on all four sides of the respective traces. The adjacent pairs of write traces may be between about 100 microns and about 200 microns. Moreover, each pair of write traces includes a first portion and a second portion, the first portion having a width of between about 10 microns and about 50 microns, and the second portion having a width of between about 30 microns and about 80 microns. Faraday cages that are implemented in the approaches herein may thereby desirably provide crosstalk protection between read and write traces that are in close proximity to each other. This allows for shielding between tighter traces, thereby further improving read and write performance by allowing for even smaller spacing and greater achievable storage densities.

In some implementations, each Faraday cage includes an EMI layer positioned between the write traces in each respective pair. Each of the EMI shields extends along a respective EMI shield plane. Moreover, the EMI layer extends along a plane that is perpendicular to each of the EMI shield planes taken along a cross-section of the respective Faraday cage. Accordingly, each of the EMI shields extends between adjacent pairs of write traces, while each EMI layer extends between the individual traces in each respective pair of write traces. Faraday cages that are implemented in the approaches herein may thereby desirably provide crosstalk protection between each individual trace. Shielding each write trace as such further improves write performance by allowing for even still tighter spacing and still greater achievable storage densities.

In different implementations, the read and write lines form an array having different numbers of data channels therein. For instance, in some implementations the read and write lines form an array having at least 32 different channels. In other implementations, the read and write lines form an array having at least 64 different channels. In other implementations, the read and write lines form an array having at least 128 different channels. Faraday cages that are implemented in the approaches herein may thereby desirably provide crosstalk protection between read and write traces that are in varying proximity to each other. This allows for shielding between tighter traces as traces and transducers continue to become smaller and closer together. As a result, read and write performance is improved by allowing for increases in achievable storage densities.

In another general approach, a tape drive cable includes: a connector, and a bond region. The tape drive cable also includes read and write lines that that include traces and that extend from the bond region to the connector. Furthermore, Faraday cages surround each of the write lines on all four sides of the respective traces in the tape drive cable.

Approaches herein are thereby desirably able to eliminate crosstalk even in confined spaces as components continue to be miniaturized. This also allows for concurrent use of an array of read transducers and an array of write transducers in a single module. By surrounding the traces in the respective write and/or read lines on all four sides, the Faraday cages are thereby able to shield adjacent traces from experiencing any crosstalk. For example, Faraday cages may be implemented on a tape drive cable stack (e.g., FPC cable) and isolate read lines from the write lines on the cable stack, using a proper ground connection. With proper grounding, these Faraday cages will desirably isolate the write signals in the cable stack and stop the induction of voltage onto the neighboring reader traces.

In some implementations, a tape drive cable with a connector and bond region is positioned in a magnetic tape drive and coupled to a magnetic tape head in a magnetic tape head module. The tape drive cable also includes read and write lines. The read and write lines form an array having at least 128 different channels. The read and write lines further include traces that extend from the bond region to the connector. Furthermore, Faraday cages surround each of the write lines on all four sides of the respective traces in the tape drive cable. The tape drive cable may thereby be able to read and/or write to 128 different data channels on a magnetic tape simultaneously and in close proximity to each other without experiencing crosstalk between the various traces.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved crosstalk removal code at block 150 for evaluating read and/or write performance experienced by a given magnetic tape head module that is coupled to a tape drive cable having Faraday cages surrounding the read and/or write lines therein. In other words, the improved crosstalk removal code at block 150 may be used to evaluate read and/or write performance achieved by a magnetic tape head module that is supplied by a cable having traces that are surrounded by Faraday cages. The Faraday cages may include any desired type of conductive and/or magnetic materials that are configured to absorb electromagnetic interference (EMI) and other types of interference (e.g., radio frequency (RF)). The Faraday cages may thereby be used to electrically shield each of the read and/or write lines from each other. This also desirably reduces the crosstalk that is experienced between the physical conductive traces in the read and write lines, particularly as spacing between the traces continues to shrink over time as magnetic tape heads increase the number of supported data channels. Thus, by evaluating performance achieved as a result of implementing cabling with Faraday cages, improved crosstalk removal code at block 150 may be able to identify the impact different types (e.g., configurations) of Faraday cages has on performance. In some approaches, the improved crosstalk removal code at block 150 may be implemented during testing and manufacture of magnetic tape head modules and/or the corresponding cabling, e.g., to produce a resulting tape drive that has an effective configuration of Faraday protection (e.g., type, amount, etc. of Faraday caging and/or shielding), e.g., as would be appreciated by one skilled in the art after reading the present description.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

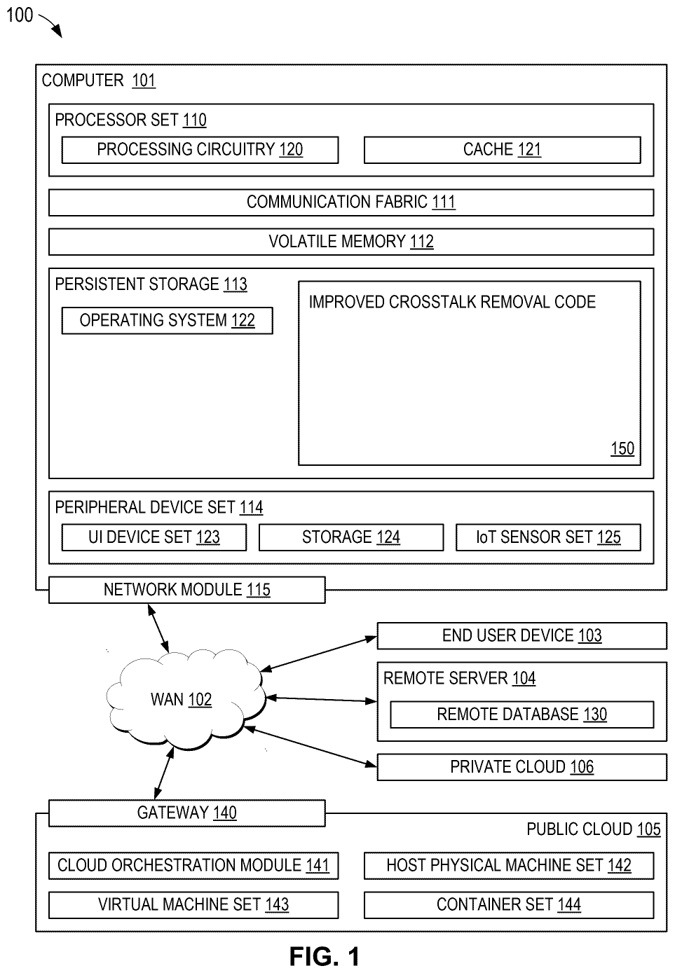

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

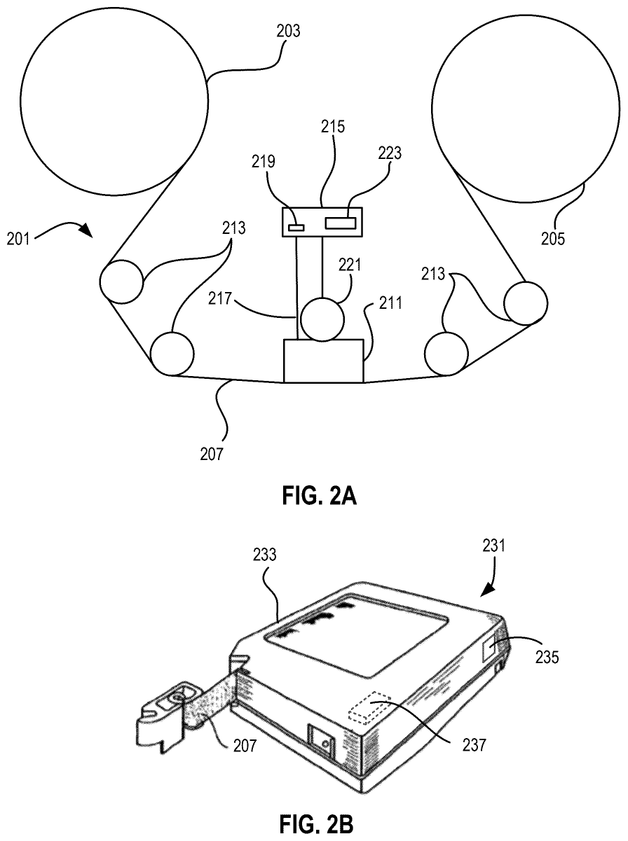

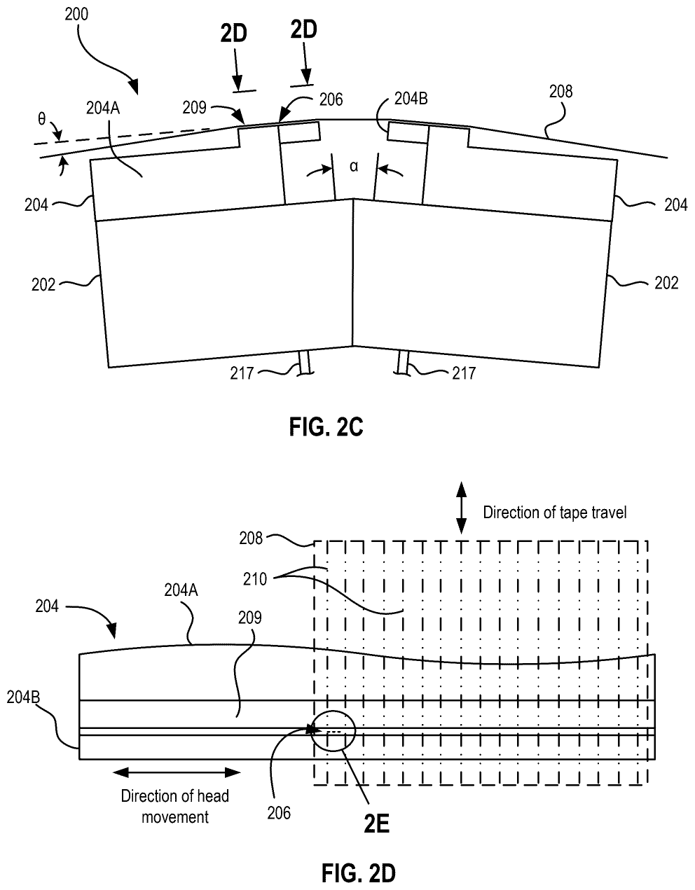

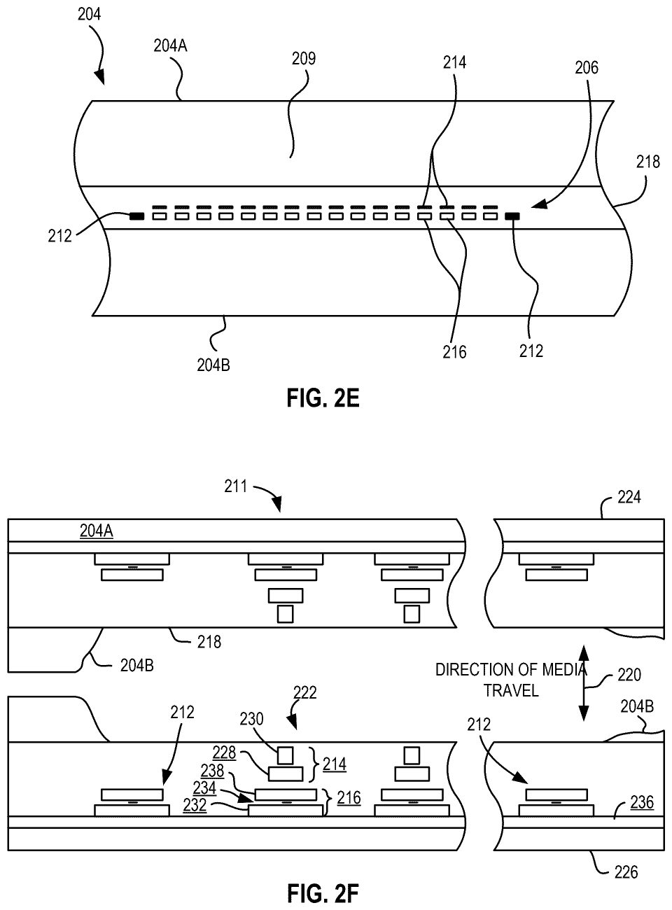

FIG. 2A illustrates a simplified tape drive 201 of a tape-based data storage system, which may be employed in the context of the present invention. While one specific implementation of a tape drive is shown in FIG. 2A, it should be noted that the approaches described herein may be implemented in the context of any type of tape drive system.

As shown, a tape supply cartridge 203 and a take-up reel 205 are provided to support a tape 207. One or more of the reels may form part of a removable cartridge and are not necessarily part of the tape drive 201. The tape drive, such as that illustrated in FIG. 2A, may further include drive motor(s) to drive the tape supply cartridge 203 and the take-up reel 205 to move the tape 207 over a tape head 211 of any type. Such head may include an array of read transducers (also referred to as readers), write transducers (also known in the art as writers), or both.

Guides 213 guide the tape 207 across the tape head 211. Such tape head 211 is in turn coupled to a controller 215 via a cable 217. The controller 215, may be or include a processor and/or any logic for controlling any subsystem of the drive 201. For example, the controller 215 typically controls head functions such as servo following, data writing, data reading, etc. The controller 215 may include at least one servo channel and at least one data channel, each of which include data flow processing logic configured to process and/or store information to be written to and/or read from the tape 207. The controller 215 may operate under logic known in the art, as well as any logic disclosed herein, and thus may be considered as a processor for any of the descriptions of tape drives included herein, in various approaches. The controller 215 may be coupled to a memory 219 of any known type, which may store instructions executable by the controller 215. Moreover, the controller 215 may be configured and/or programmable to perform or control some or all of the methodology presented herein. Thus, the controller 215 may be considered to be configured to perform various operations by way of logic programmed into one or more chips, modules, and/or blocks; software, firmware, and/or other instructions being available to one or more processors; etc., and combinations thereof.

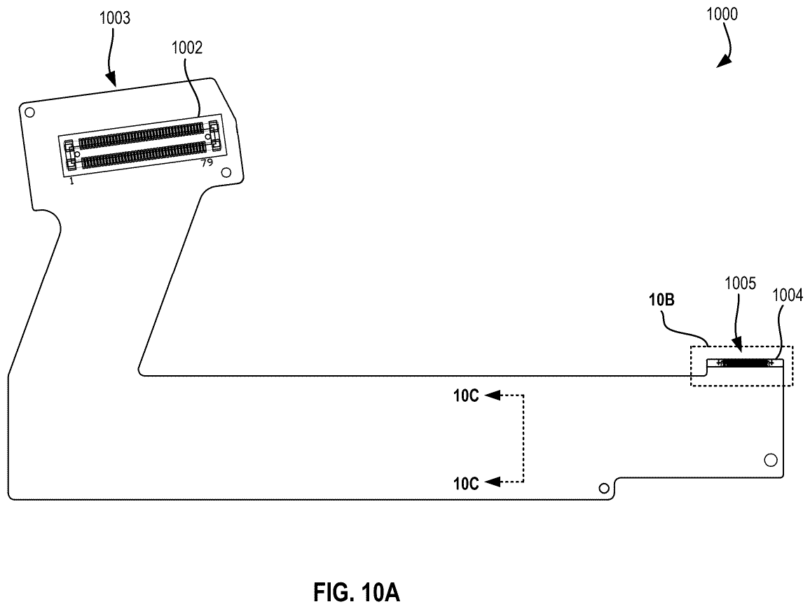

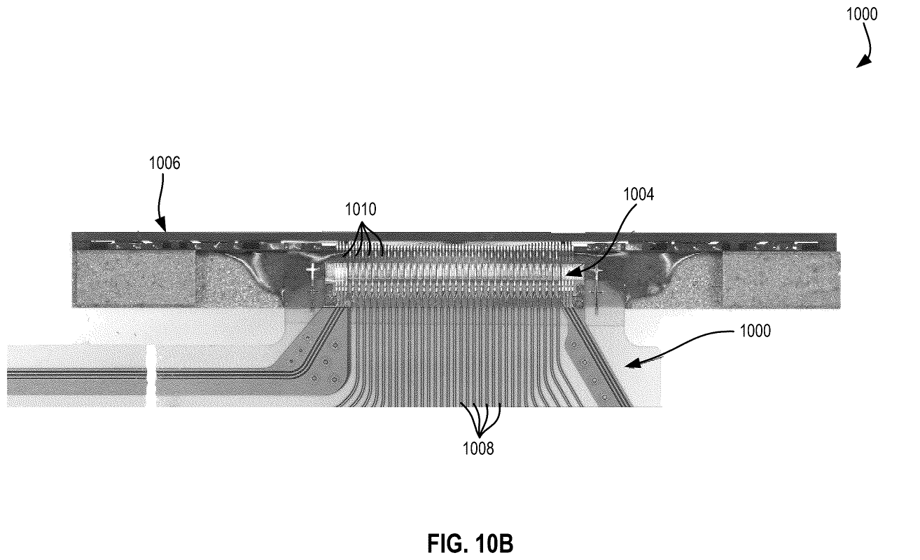

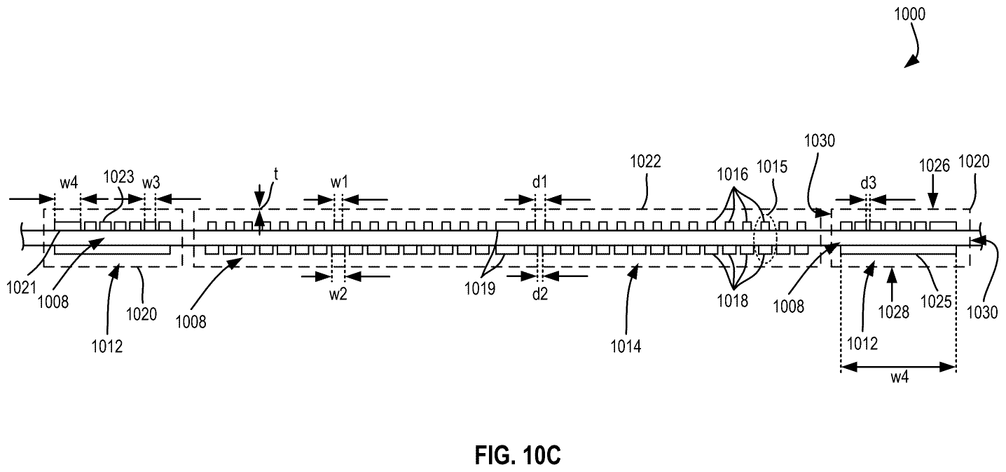

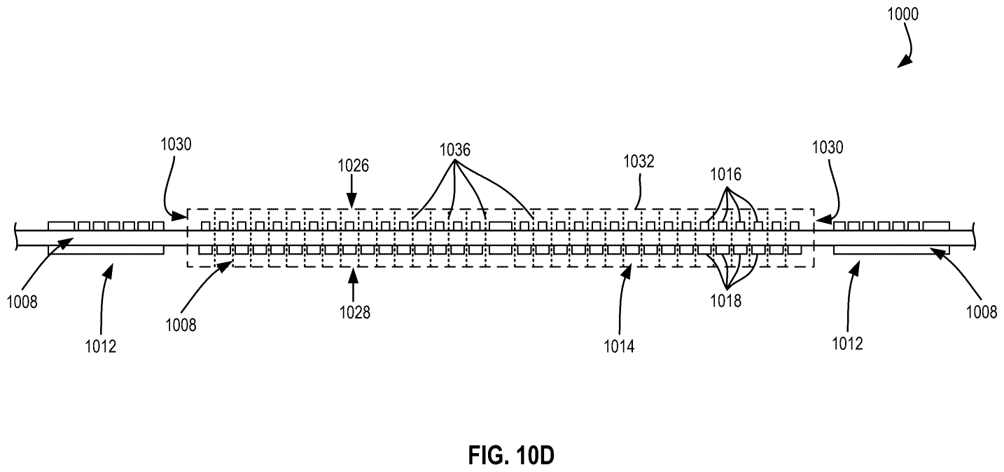

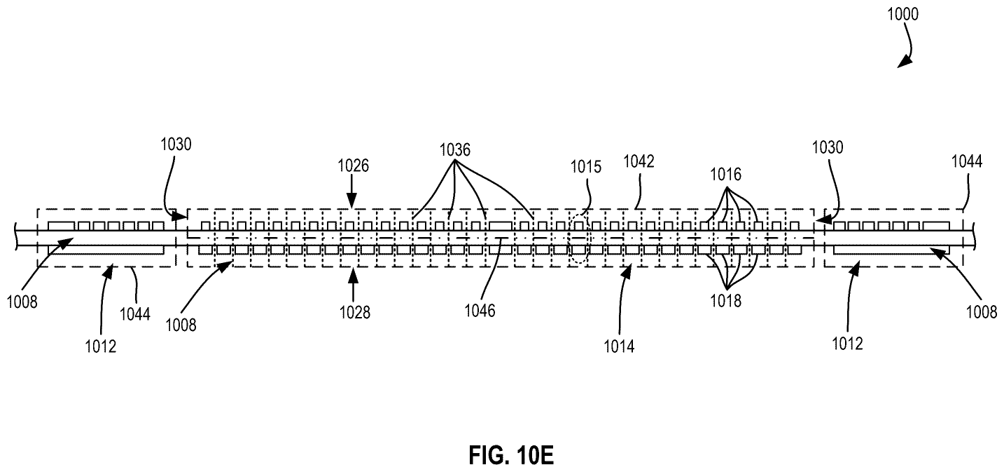

The cable 217 may include read/write circuits to transmit data to the tape head 211 to be recorded on the tape 207 and to receive data read by the tape head 211 from the tape 207. It also includes the cable transmitting the servo data and thereby controlling the position of the head relative to the tape. In preferred approaches, the cable 217 also includes one or more Faraday cages that encircle the write and/or read lines that are in the cable 217, e.g., as described in further detail below in FIGS. 10A-10E. An actuator 221 controls position of the tape head 211 relative to the tape 207. The cables providing the servo information in FIG. 10C is shielded by the Faraday cage indicated as 1012 or 1020 from the writer elements. Alternatively, a Faraday cage in 1022 is shielding the writer from the surrounding ones. As the Faraday cage only shields the surrounding ones, these two options have different strategies. In case of the cages 1012 and 1020 the cage prevents crosstalk reaching the servo readers. In the case of cage 1022 the crosstalk created by the writers is contained within the box 1022. However the crosstalk between the writers may be possibly higher or lower by adding this cage. One way to even reduce the crosstalk between each writer would be to create multiple cages, e.g., such as 32 cages that are each surrounding the 32 writers to eliminate crosstalk between writers (not shown).

An interface 223 may also be provided for communication between the tape drive 201 and a host (internal or external) to send and receive the data and for controlling the operation of the tape drive 201 and communicating the status of the tape drive 201 to the host, all as will be understood by those of skill in the art.

FIG. 2B illustrates an exemplary tape cartridge 231, according to one approach. Such tape cartridge 231 may be used with a system such as that shown in FIG. 2A. As shown, the tape cartridge 231 includes a housing 233, a tape 207 in the housing 233, and a nonvolatile memory 237 coupled to the housing 233. In some approaches, the nonvolatile memory 237 may be embedded inside the housing 233, as shown in FIG. 2B. In more approaches, the nonvolatile memory 237 may be attached to the inside or outside of the housing 233 without modification of the housing 233. For example, the nonvolatile memory may be embedded in a self-adhesive label 235. In one preferred approach, the nonvolatile memory 237 may be a Flash memory device, read-only memory (ROM) device, etc., embedded into or coupled to the inside or outside of the tape cartridge 231. The nonvolatile memory is accessible by the tape drive and the tape operating software (the driver software), and/or another device.

By way of example, FIG. 2C illustrates a side view of a flat-lapped, bi-directional, two-module magnetic tape head 211 which may be implemented in the context of the present invention. As shown, the head includes a pair of bases 202, each equipped with a module 204, and fixed at a small angle α with respect to each other. The bases may be “U-beams” that are adhesively coupled together. Each module 204 includes a substrate 204A and a closure 204B with a thin film portion, commonly referred to as a “gap” in which the read transducers and/or write transducers 206 are formed. In use, a tape 208 is moved over the modules 204 along a media (tape) bearing surface 209 in the manner shown for reading and writing data on the tape 208 using the read transducers and write transducers. The wrap angle θ of the tape 208 at edges going onto and exiting the flat media support surfaces 209 are usually between about 0.1 degree and about 3 degrees.

The substrates 204A are typically constructed of a wear resistant material, such as a ceramic. The closures 204B may be made of the same or similar ceramic as the substrates 204A.

Cables 217 are provided for enabling communication between the controller and the transducers 206 of each of the modules 204. Pads on a cable 217 are typically wire bonded to pads on the associated module 204. Moreover, in preferred approaches, the cable 217 also includes a number of Faraday cages that encircle the write and/or read lines in the cable 217, e.g., as described in further detail below in FIGS. 10A-10E.

The read transducers and write transducers may be arranged in a piggyback or merged configuration. An illustrative piggybacked configuration comprises a (magnetically inductive) write transducer on top of (or below) a (magnetically shielded) read transducer (e.g., a magnetoresistive reader, etc.), wherein the poles of the write transducer and the shields of the read transducer are generally separated. An illustrative merged configuration comprises one reader shield in the same physical layer as one writer pole (hence, “merged”). The read transducers and write transducers may also be arranged in an interleaved configuration. Alternatively, each array of channels may be read transducers or write transducers only. Any of these arrays may contain one or more servo readers for reading servo data on the medium.

FIG. 2D illustrates the tape bearing surface 209 of one of the modules 204 taken from Line 2D of FIG. 2C. A representative tape 208 is shown in dashed lines. The module 204 is preferably long enough to be able to support the tape as the head steps between data bands.

In this example, the tape 208 includes 4 to 32 data bands, e.g., with 16 data bands and 17 servo tracks 210, as shown in FIG. 2D on a one-half inch wide tape 208. The data bands are defined between servo tracks 210. Each data band may include a number of data tracks, for example 1024 data tracks (not shown). During read/write operations, the read transducers and/or write transducers 206 are positioned to specific track positions within one of the data bands. Outer readers, sometimes called servo readers, read the servo tracks 210. The servo signals are in turn used in a conventional manner to keep the read transducers and/or write transducers 206 aligned with a particular set of tracks during the read/write operations.

FIG. 2E depicts a plurality of read transducers and/or write transducers 206 formed in a gap 218 on the module 204 in Circle 2E of FIG. 2D. As shown in FIG. 2E, the array of read transducers and write transducers 206 includes, for example, 16 write transducers 214, 16 read transducers 216 and two servo readers 212, though the number of elements may vary. Illustrative approaches include 8, 16, 32, 40, and 64 active read transducers and/or write transducers 206 per array, and alternatively interleaved designs having odd numbers of read transducers or write transducers such as 17, 25, 33, etc. An illustrative approach includes 32 read transducers per array and/or 32 write transducers per array, where the actual number of transducer elements could be greater, e.g., 33, 34, etc. Multiple simultaneously-operated transducers allow the tape to travel at a modest velocity while maintaining a high data transfer rate. Lower velocities are desirable to reduce mechanical difficulties from speed-induced tracking.

While the read transducers and write transducers may be arranged in a piggyback configuration as shown in FIG. 2E, the read transducers 216 and write transducers 214 may also be arranged in an interleaved configuration. Alternatively, each array of read transducers and/or write transducers 206 may be read transducers or write transducers only, and the arrays may contain one or more servo readers 212. As noted by considering FIGS. 2C and 2D-2E together, each module 204 may include a complementary set of read transducers and/or write transducers 206 for such things as bi-directional reading and writing, read-while-write capability, backward compatibility, etc.

FIG. 2F shows a partial tape bearing surface view of complementary modules of a magnetic tape head 211, according to one approach. In this approach, each module has a plurality of read/write (R/W) pairs in a piggyback configuration formed on a common substrate 204A and an optional electrically insulative insulating layer 236. The write transducers 214 and the read transducers 216 are aligned parallel to an intended direction of travel of a tape medium thereacross to form an R/W pair, exemplified by R/W pairs 222. Note that the intended direction of tape travel is sometimes referred to herein as the direction of tape travel, and such terms may be used interchangeably. Such direction of tape travel may be inferred from the design of the system, e.g., by examining the guides; observing the actual direction of tape travel relative to the reference point; etc. Moreover, in a system operable for bi-direction reading and/or writing, the direction of tape travel in both directions is typically parallel and thus both directions may be considered equivalent to each other.

Several R/W pairs 222 may be present, such as 8, 16, 32 pairs, etc. The R/W pairs 222 as shown are linearly aligned in a direction generally perpendicular to a direction of tape travel thereacross. However, the pairs may also be aligned diagonally, etc. Servo readers 212 are positioned on the outside of the array of R/W pairs, the function of which is well known.

Generally, the magnetic tape medium moves in either a forward or reverse direction as indicated by arrow 220. The magnetic tape medium and head assembly 211 operate in a transducing relationship in the manner well-known in the art. The head assembly 211 includes two thin-film modules 224 and 226 of generally identical construction.

Modules 224 and 226 are joined together with a space present between closures 204B thereof (partially shown) to form a single physical unit to provide read-while-write capability by activating the write transducer of the leading module and read transducer of the trailing module aligned with the write transducer of the leading module parallel to the direction of tape travel relative thereto. When a module 224, 226 of a magnetic tape head 211 is constructed, layers are formed in the gap 218 created above an electrically conductive substrate 204A (partially shown), e.g., of AlTiC, in generally the following order for the R/W pairs 222: an insulating layer 236, a first shield 232 typically of an iron alloy such as NiFe (e.g., ˜80/20 at % NiFe, also known as permalloy), cobalt zirconium tantalum (CZT) or Al—Fe—Si (Sendust), a sensor 234 for sensing a data track on a magnetic medium, a second shield 238 typically of a nickel-iron alloy (e.g., permalloy), first and second writer poles 228, 230, and a coil (not shown). The sensor may be of any known type, including those based on magnetoresistive (MR), GMR, AMR, tunneling magnetoresistance (TMR), etc.

The first and second writer poles 228, 230 may be fabricated from high magnetic moment materials such as CoFe. Note that these materials are provided by way of example only, and other materials may be used. Additional layers such as insulation between the shields and/or pole tips and an insulation layer surrounding the sensor may be present. Illustrative materials for the insulation include alumina and other oxides, insulative polymers, etc.

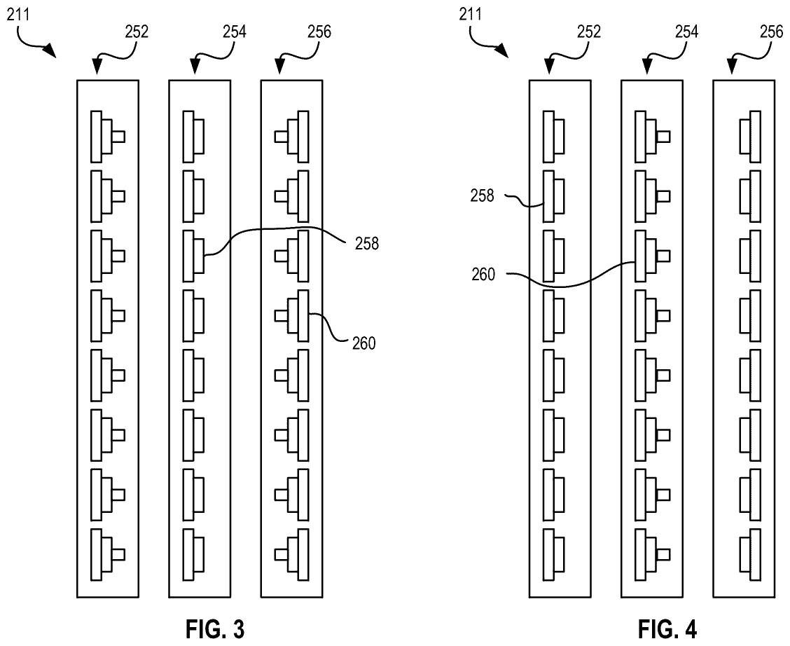

The configuration of the tape head 211, according to one approach, includes multiple modules, preferably three or more. In a write-read-write (W-R-W) head, outer modules for writing flank one or more inner modules for reading. Referring to FIG. 3, depicting a W-R-W configuration, the outer modules 252, 256 each include one or more arrays of write transducers 260. The inner module 254 of FIG. 3 includes one or more arrays of read transducers 258 in a similar configuration. Variations of a multi-module head include a R-W-R head (FIG. 4), a R-R-W head, a W-W-R head, etc. In yet other variations, one or more of the modules may have read/write pairs of transducers. Moreover, more than three modules may be present. In further approaches, two outer modules may flank two or more inner modules, e.g., in a W-R-R-W, a R-W-W-R arrangement, etc. For simplicity, a W-R-W head is used primarily herein to exemplify approaches of the present invention. One skilled in the art apprised with the teachings herein will appreciate how permutations of the present invention would apply to configurations other than a W-R-W configuration.

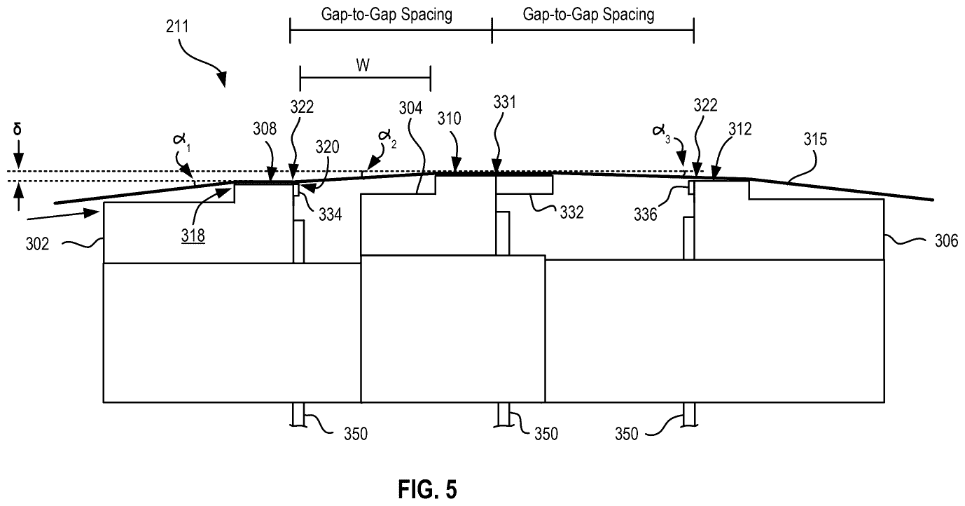

FIG. 5 illustrates a magnetic head 211 according to one approach of the present invention that includes first, second and third modules 302, 304, 306 each having a tape bearing surface 308, 310, 312 respectively, which may be flat, contoured, etc. Note that while the term “tape bearing surface” appears to imply that the surface facing the tape 315 is in physical contact with the tape bearing surface, this is not necessarily the case. Rather, only a portion of the tape may be in contact with the tape bearing surface, constantly or intermittently, with other portions of the tape riding (or “flying”) above the tape bearing surface on a layer of air, sometimes referred to as an “air bearing”. The first module 302 will be referred to as the “leading” module as it is the first module encountered by the tape in a three module design for tape moving in the indicated direction. The third module 306 will be referred to as the “trailing” module. The trailing module follows the middle module and is the last module seen by the tape in a three module design. The leading and trailing modules 302, 306 are referred to collectively as outer modules. Also note that the outer modules 302, 306 will alternate as leading modules, depending on the direction of travel of the tape 315.

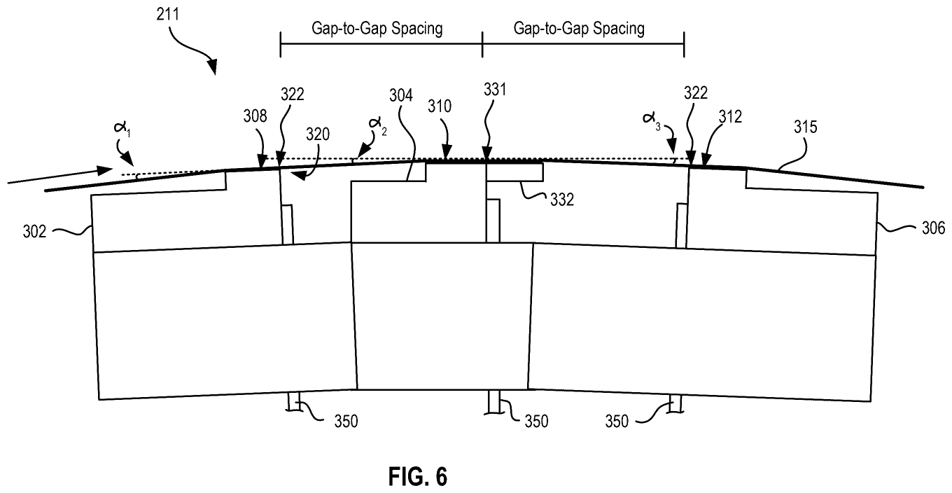

In one approach, the tape bearing surfaces 308, 310, 312 of the first, second and third modules 302, 304, 306 lie on about parallel planes (which is meant to include parallel and nearly parallel planes, e.g., between parallel and tangential as in FIG. 6), and the tape bearing surface 310 of the second module 304 is above the tape bearing surfaces 308, 312 of the first and third modules 302, 306. As described below, this has the effect of creating the desired wrap angle α₂ of the tape relative to the tape bearing surface 310 of the second module 304.

Where the tape bearing surfaces 308, 310, 312 lie along parallel or nearly parallel yet offset planes, intuitively, the tape should peel off of the tape bearing surface 308 of the leading module 302. However, the vacuum created by a skiving edge 318 of the leading module 302 has been found by experimentation to be sufficient to keep the tape adhered to the tape bearing surface 308 of the leading module 302. A trailing edge 320 of the leading module 302 (the end from which the tape leaves the leading module 302) is the approximate reference point which defines the wrap angle α₂ over the tape bearing surface 310 of the second module 304. The tape stays in close proximity to the tape bearing surface until close to the trailing edge 320 of the leading module 302. Accordingly, transducers 322 may be located near the trailing edges of the outer modules 302, 306. These approaches are particularly adapted for write-read-write applications.

A benefit of this and other approaches described herein is that, because the outer modules 302, 306 are fixed at a determined offset from the second module 304, the inner wrap angle α₂ is fixed when the modules 302, 304, 306 are coupled together or are otherwise fixed into a head. The inner wrap angle α₂ is approximately tan⁻¹ (δ/W) where δ is the height difference between the planes of the tape bearing surfaces 308, 310 and W is the width between the opposing ends of the tape bearing surfaces 308, 310. An illustrative inner wrap angle α₂ is in a range of about 0.3° to about 1.1°, though can be any angle required by the design.

Beneficially, the inner wrap angle α₂ on the side of the module 304 receiving the tape (leading edge) will be larger than the inner wrap angle α₃ on the trailing edge, as the tape 315 rides above the trailing module 306. This difference is generally beneficial as a smaller α₃ tends to oppose what has heretofore been a steeper exiting effective wrap angle.

Note that the tape bearing surfaces 308, 312 of the outer modules 302, 306 are positioned to achieve a negative wrap angle at the trailing edge 320 of the leading module 302. This is generally beneficial in helping to reduce friction due to contact with the trailing edge 320, provided that proper consideration is given to the location of the crowbar region that forms in the tape where it peels off the head. This negative wrap angle also reduces flutter and scrubbing damage to the elements on the leading module 302. Further, at the trailing module 306, the tape 315 flies over the tape bearing surface 312 so there is virtually no wear on the elements when tape is moving in this direction. Particularly, the tape 315 entrains air and so will not significantly ride on the tape bearing surface 312 of the third module 306 (some contact may occur). This is permissible, because the leading module 302 is writing while the trailing module 306 is idle.

Writing and reading functions are performed by different modules at any given time. In one approach, the second module 304 includes a plurality of data and optional servo readers 331 and no write transducers. The first and third modules 302, 306 include a plurality of write transducers 322 and no data read transducers, with the exception that the outer modules 302, 306 may include optional servo readers. The servo readers may be used to position the head during reading and/or writing operations. The servo reader(s) on each module are typically located towards the end of the array of read transducers or write transducers.

By having only read transducers or side by side write transducers and servo readers in the gap between the substrate and closure, the gap length can be substantially reduced. Typical heads have piggybacked read transducers and write transducers, where the write transducer is formed above each read transducer. A typical gap is 20-35 microns (μm). However, irregularities on the tape may tend to droop into the gap and create gap erosion. Thus, the smaller the gap the better. The smaller gap enabled herein exhibits fewer wear related problems.

In some approaches, the second module 304 has a closure, while the first and third modules 302, 306 do not have a closure. Where there is no closure, preferably a hard coating is added to the module. One preferred coating is diamond-like carbon (DLC).

In the approach shown in FIG. 5, the first, second, and third modules 302, 304, 306 each have a closure 332, 334, 336, which extends the tape bearing surface of the associated module, thereby effectively positioning the read/write elements away from the edge of the tape bearing surface. The closure 332 on the second module 304 can be a ceramic closure of a type typically found on tape heads. The closures 334, 336 of the first and third modules 302, 306, however, may be shorter than the closure 332 of the second module 304 as measured parallel to a direction of tape travel over the respective module. This enables positioning of the modules closer together. One way to produce shorter closures 334, 336 is to lap the standard ceramic closures of the second module 304 an additional amount. Another way is to plate or deposit thin film closures above the elements during thin film processing. For example, a thin film closure of a hard material such as Sendust or nickel-iron alloy (e.g., 45/55) can be formed on the module.

With reduced-thickness ceramic or thin film closures 334, 336 or no closures on the outer modules 302, 306, the write-to-read gap spacing can be reduced to less than about 1 mm, e.g., about 0.75 mm, or 50% less than commonly-used linear tape open (LTO) tape head spacing. The open space between the modules 302, 304, 306 can still be set to approximately 0.5 to 0.6 mm, which in some approaches is ideal for stabilizing tape motion over the second module 304.

Depending on tape tension and stiffness, it may be desirable to angle the tape bearing surfaces of the outer modules relative to the tape bearing surface of the second module. FIG. 6 illustrates an approach where the modules 302, 304, 306 are in a tangent or nearly tangent (angled) configuration. Particularly, the tape bearing surfaces of the outer modules 302, 306 are about parallel to the tape at the desired wrap angle α₂ of the second module 304. In other words, the planes of the tape bearing surfaces 308, 312 of the outer modules 302, 306 are oriented at about the desired wrap angle α₂ of the tape 315 relative to the second module 304. The tape will also pop off of the trailing module 306 in this approach, thereby reducing wear on the elements in the trailing module 306. These approaches are particularly useful for write-read-write applications. Additional aspects of these approaches are similar to those given above.

Typically, the tape wrap angles may be set about midway between the approaches shown in FIGS. 5 and 6.

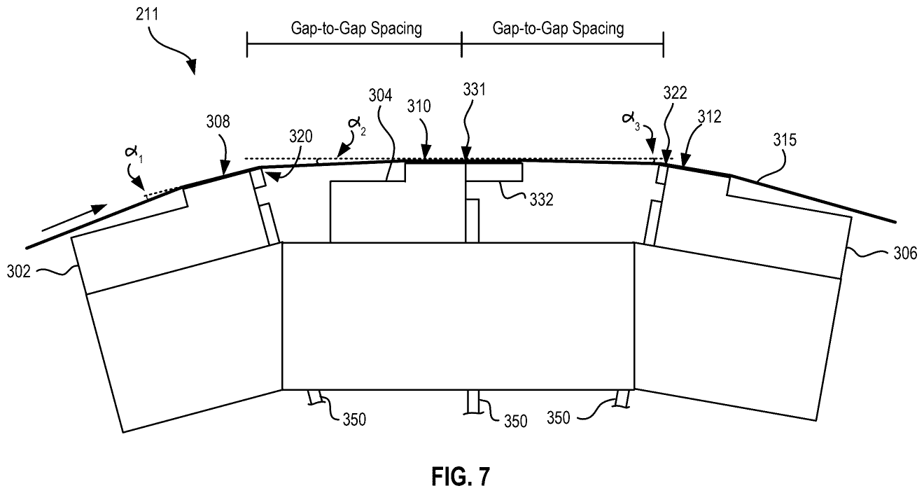

FIG. 7 illustrates an approach where the modules 302, 304, 306 are in an overwrap configuration. Particularly, the tape bearing surfaces 308, 312 of the outer modules 302, 306 are angled slightly more than the tape 315 when set at the desired wrap angle α₂ relative to the second module 304. In this approach, the tape does not pop off of the trailing module, allowing it to be used for writing or reading. Accordingly, the leading and middle modules can both perform reading and/or writing functions while the trailing module can read any just-written data. Thus, these approaches are preferred for write-read-write, read-write-read, and write-write-read applications. In the latter approaches, closures should be wider than the tape canopies for ensuring read capability. The wider closures may require a wider gap-to-gap separation. Therefore, a preferred approach has a write-read-write configuration, which may use shortened closures that thus allow closer gap-to-gap separation.

Additional aspects of the approaches shown in FIGS. 6 and 7 are similar to those given above.

A 32 channel version of a multi-module tape head 211 may use cables 350 having leads on the same or smaller pitch, or alternatively the connections on the module may be interleaved for a 50% reduction in cable span. Over-under, writing pair unshielded cables may be used for the write transducers, which may have integrated servo readers. In preferred approaches, the cables 350 also include one or more Faraday cages that encircle the write and/or read lines that are in the cable 350, e.g., as described in further detail below in FIGS. 10A-10E.

The outer wrap angles α₁ may be set in the drive, such as by guides of any type known in the art, such as adjustable rollers, slides, etc. or alternatively by outriggers, which are integral to the head. For example, rollers having an offset axis may be used to set the wrap angles. The offset axis creates an orbital arc of rotation, allowing precise alignment of the wrap angle α₁.

To assemble any of the approaches described above, conventional u-beam assembly can be used. Accordingly, the mass of the resultant head may be maintained or even reduced relative to heads of previous generations. In other approaches, the modules may be constructed as a unitary body. Those skilled in the art, armed with the present teachings, will appreciate that other known methods of manufacturing such heads may be adapted for use in constructing such heads. Moreover, unless otherwise specified, processes and materials of types known in the art may be adapted for use in various approaches in conformance with the teachings herein, as would become apparent to one skilled in the art upon reading the present disclosure.

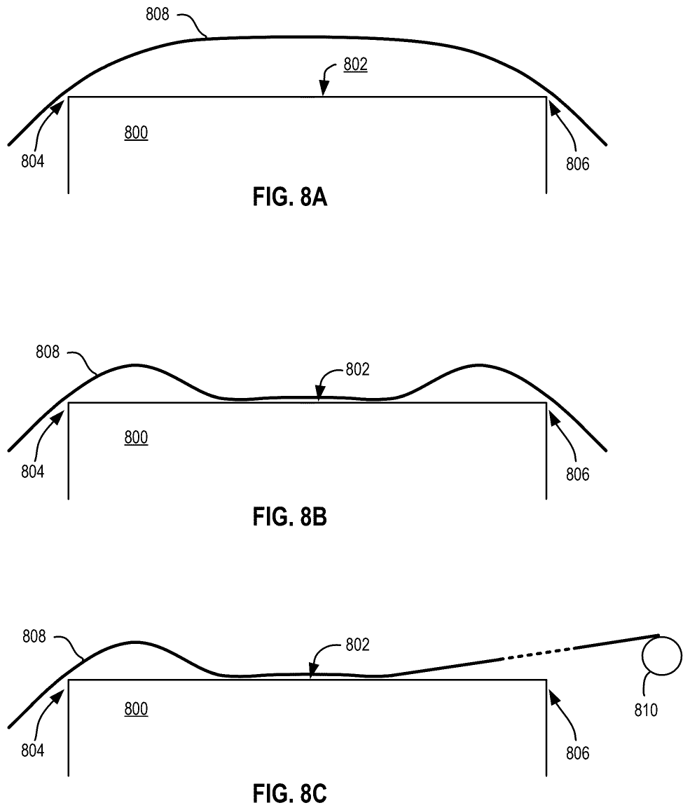

As a tape is run over a module, it is preferred that the tape passes sufficiently close to magnetic transducers on the module such that reading and/or writing is efficiently performed, e.g., with a low error rate. According to some approaches, tape tenting may be used to ensure the tape passes sufficiently close to the portion of the module having the magnetic transducers. To better understand this process, FIGS. 8A-8C illustrate the principles of tape tenting. FIG. 8A shows a module 800 having an upper tape bearing surface 802 extending between opposite edges 804, 806. A stationary tape 808 is shown wrapping around the edges 804, 806. As shown, the bending stiffness of the tape 808 lifts the tape off of the tape bearing surface 802. Tape tension tends to flatten the tape profile, as shown in FIG. 8A. Where tape tension is minimal, the curvature of the tape is more parabolic than shown.

FIG. 8B depicts the tape 808 in motion. The leading edge, i.e., the first edge the tape encounters when moving, may serve to skive air from the tape, thereby creating a subambient air pressure between the tape 808 and the tape bearing surface 802. In FIG. 8B, the leading edge is the left edge, and the right edge is the trailing edge when the tape is moving left to right. As a result, atmospheric pressure above the tape urges the tape toward the tape bearing surface 802, thereby creating tape tenting proximate each of the edges. The tape bending stiffness resists the effect of the atmospheric pressure, thereby causing the tape tenting proximate both the leading and trailing edges. Modeling predicts that the two tents are very similar in shape.

FIG. 8C depicts how the subambient pressure urges the tape 808 toward the tape bearing surface 802 even when a trailing guide 810 is positioned above the plane of the tape bearing surface.

It follows that tape tenting may be used to direct the path of a tape as it passes over a module. As previously mentioned, tape tenting may be used to ensure the tape passes sufficiently close to the portion of the module having the magnetic transducers, preferably such that reading and/or writing is efficiently performed, e.g., with a low error rate.

Magnetic tapes may be stored in tape cartridges that are, in turn, stored at storage slots or the like inside a data storage library. The tape cartridges may be stored in the library such that they are accessible for physical retrieval. In addition to magnetic tapes and tape cartridges, data storage libraries may include data storage drives that store data to, and/or retrieve data from, the magnetic tapes. Moreover, tape libraries and the components included therein may implement a file system which enables access to tape and data stored on the tape.

File systems may be used to control how data is stored in, and retrieved from, memory. Thus, a file system may include the processes and data structures that an operating system uses to keep track of files in memory, e.g., the way the files are organized in memory. Linear Tape File System (LTFS) is an exemplary format of a file system that may be implemented in a given library in order to enable access to compliant tapes. It should be appreciated that various approaches herein can be implemented with a wide range of file system formats, including for example IBM® Spectrum® Archive Library Edition (LTFS LE) (IBM and all IBM-based trademarks and logos are trademarks or registered trademarks of International Business Machines Corporation and/or its affiliates). However, to provide a context, and solely to assist the reader, some of the approaches below may be described with reference to LTFS, which is a type of file system format. This has been done by way of example only, and should not be deemed limiting on the invention defined in the claims.

A tape cartridge may be “loaded” by inserting the cartridge into the tape drive, and the tape cartridge may be “unloaded” by removing the tape cartridge from the tape drive. Once loaded in a tape drive, the tape in the cartridge may be “threaded” through the drive by physically pulling the tape (the magnetic recording portion) from the tape cartridge, and passing it above a magnetic head of a tape drive. Furthermore, the tape may be attached on a take-up reel (e.g., see 205 of FIG. 2A above) to move the tape over the magnetic head.

Once threaded in the tape drive, the tape in the cartridge may be “mounted” by reading metadata on a tape and bringing the tape into a state where the LTFS is able to use the tape as a constituent component of a file system. Moreover, in order to “unmount” a tape, metadata is preferably first written on the tape (e.g., as an index), after which the tape may be removed from the state where the LTFS is allowed to use the tape as a constituent component of a file system. Finally, to “unthread” the tape, the tape is unattached from the take-up reel and is physically placed back into the inside of a tape cartridge again. The cartridge may remain loaded in the tape drive even after the tape has been unthreaded, e.g., waiting for another read and/or write request. However, in other instances, the tape cartridge may be unloaded from the tape drive upon the tape being unthreaded, e.g., as described above.

Magnetic tape is a sequential access medium. Thus, new data is written to the tape by appending the data at the end of previously written data. It follows that when data is recorded in a tape having only one partition, metadata (e.g., allocation information) is continuously appended to an end of the previously written data as it frequently updates and is accordingly rewritten to tape. As a result, the rearmost information is read when a tape is first mounted in order to access the most recent copy of the metadata corresponding to the tape. However, this introduces a considerable amount of delay in the process of mounting a given tape.

To overcome this delay caused by single partition tape mediums, the LTFS format includes a tape that is divided into two partitions, which include an index partition and a data partition. The index partition may be configured to record metadata (meta information), e.g., such as file allocation information (Index), while the data partition may be configured to record the body of the data, e.g., the data itself.

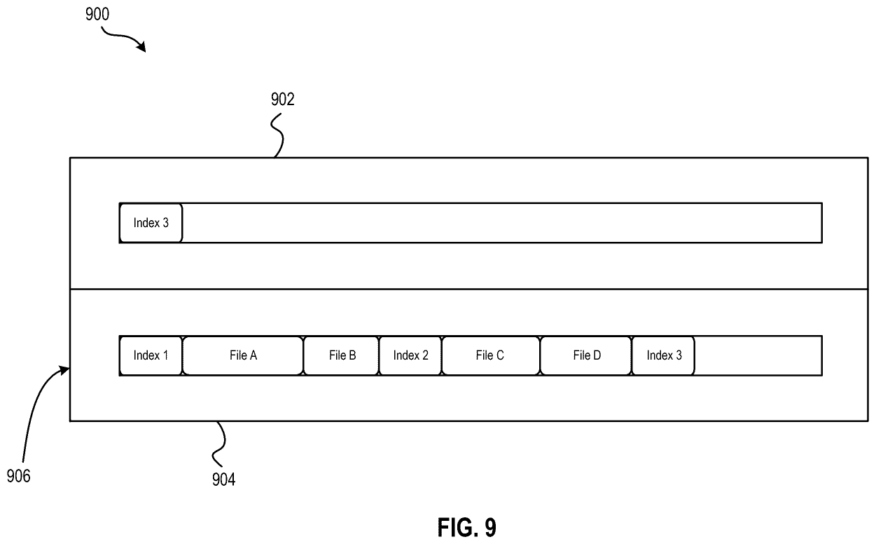

Looking to FIG. 9, a magnetic tape 900 having an index partition 902 and a data partition 904 is illustrated, according to one approach. As shown, data files and indexes are stored on the tape. The LTFS format allows for index information to be recorded in the index partition 902 at the beginning of tape 906, as would be appreciated by one skilled in the art upon reading the present description.

As index information is updated, it preferably overwrites the previous version of the index information, thereby allowing the currently updated index information to be accessible at the beginning of tape in the index partition. According to the specific example illustrated in FIG. 9, a most recent version of metadata Index 3 is recorded in the index partition 902 at the beginning of the tape 906. Conversely, all three versions of metadata Index 1, Index 2, Index 3 as well as data File A, File B, File C, File D are recorded in the data partition 904 of the tape. Although Index 1 and Index 2 are old (e.g., outdated) indexes, because information is written to tape by appending it to the end of the previously written data as described above, these old indexes Index 1, Index 2 remain stored on the tape 900 in the data partition 904 without being overwritten.

The metadata may be updated in the index partition 902 and/or the data partition 904 the same or differently depending on the desired approach. According to some approaches, the metadata of the index and/or data partitions 902, 904 may be updated in response to the tape being unmounted, e.g., such that the index may be read quickly from the index partition when that tape is mounted again. The metadata is preferably also written in the data partition 904 so the tape may be mounted using the metadata recorded in the data partition 904, e.g., as a backup option.

According to one example, which is no way intended to limit the invention, LTFS LE may be used to provide the functionality of writing an index in the data partition when a user explicitly instructs the system to do so, or at a time designated by a predetermined period which may be set by the user, e.g., such that data loss in the event of sudden power stoppage can be mitigated.

As previously mentioned, magnetic transducers read data from and write data onto magnetic recording media. Data is written on the magnetic recording media by moving a magnetic recording transducer to a position over the media where the data is to be stored. The magnetic recording transducer then generates a magnetic field, which encodes the data into the magnetic media. Data is read from the media by similarly positioning the magnetic read transducer and then sensing the magnetic field of the magnetic media. Read and write operations may be independently synchronized with the movement of the media to ensure that the data can be read from and written to the desired location on the media.

An important and continuing goal in the data storage industry is that of increasing the density of data stored on a medium. For magnetic storage systems, that goal has led to increasing the track and linear bit density on the recording media, and in some cases, decreasing the thickness of the magnetic recording medium. However, the development of small footprint, higher performance magnetic recording systems has created various challenges ranging from the design of magnetic head assemblies for use in such systems to dealing with media dimensional instability.

One particular problem that has prevented further miniaturization of magnetic head assemblies is that of crosstalk. Crosstalk primarily results from inductive and capacitive coupling between adjacent leads. Crosstalk between the leads appears as noise in the readback signal, which adversely affects the critical signal to noise ratio, leading to limits in data rate, increased read error rate, etc. It is also desirable to increase achievable data transfer rates. This, however, is challenging as it involves additional heads, which in turn involve more connections in the same space available, leading to increased crosstalk without any preventative measures taken.

Some magnetic storage systems utilize read-while-write verification, in which the just-written data is read by a trailing read transducer array to verify that the data was written correctly. Crosstalk between the writer leads and reader leads in conventional products has heretofore been believed to be so severe as to prevent the use of concurrently-active write and read transducer arrays on a single module. Accordingly, modern magnetic data storage systems have utilized separate modules to house the array of read transducers and the array of write transducers that are concurrently active during read-while-write verification. Moreover, this problem has only become more severe as data storage densities continue to increase. For instance, as magnetic tape drives are developed to read and/or write 32 channels, 64 channels, 128 channels, etc. simultaneously, the continued miniaturization of the corresponding physical components significantly increases the effects of crosstalk that are experienced during use.

Furthermore, even separating concurrently-active arrays into separate modules results in several problems of its own. For instance, during fabrication each module must be post-wafer processed, such that a three-module head requires three post-wafer processes. Moreover, alignment of the arrays on the separate modules is extremely difficult, resulting in large variations in alignment from head to head. Each module has a separate cable, increasing cost. In addition, the higher weight of a multi-module head requires more power for track following, and makes movement of the head less nimble.

What is needed is an apparatus that eliminates crosstalk while allowing concurrent use of an array of read transducers and an array of write transducers in a single module. In sharp contrast to these conventional shortcomings, approaches herein are desirably able to implement one or more Faraday cages around the write and/or read lines of a magnetic head. According to preferred approaches, the Faraday cages each extend from the bond region of the write and/or read lines, all the way to a connector that couples the actual traces to a controller. Each Faraday cage preferably surrounds the traces in the respective write and/or read lines on all four sides, thereby shielding adjacent traces from experiencing any crosstalk. In other words, a Faraday cage preferably fully contains a respective read or write line therein. For example, Faraday cages may be implemented on a tape drive cable stack (e.g., flexible printed circuit (FPC) cable) and isolate read lines from the write lines on the cable stack, using a proper ground connection. With proper grounding, these Faraday cages will isolate the write signals in the cable stack and stop the induction of voltage onto the neighboring reader traces or the servo reader tracks within the same module, e.g., as will be described in further detail below.

Looking now to FIGS. 10A-10C, different views of a tape drive cable 1000 having read and write lines therein are shown in accordance with one approach. As an option, the present tape drive cable 1000 may be implemented in conjunction with features from any other approach listed herein, such as those described with reference to the other FIGS. However, such tape drive cable 1000 and others presented herein may be used in various applications and/or in permutations which may or may not be specifically described in the illustrative approaches listed herein. Further, the tape drive cable 1000 presented herein may be used in any desired environment. For example, FIGS. 10D-10E illustrate different configurations of Faraday cages that may be used to surround the write and/or read lines. Thus FIGS. 10A-10C (and the other FIGS.) may be deemed to include any possible permutation.

As shown, the tape drive cable 1000 includes a connector 1002 as well as a bond region 1004. While the connector 1002 is positioned towards a first end 1003 of the tape drive cable 1000 and the bond region 1004 is positioned towards a second end 1005 of the tape drive cable 1000, the connector 1002 and bond region 1004 are connected by read and write lines extending therebetween. Each of the read and write lines further include a plurality of traces (e.g., as seen in FIGS. 10B-10C) that extend between the connector 1002 and bond region 1004. It follows that each of the physical traces in the read and write lines are able to carry information (e.g., data, signals, binary values, metadata, etc.) between the connector 1002 and bond region 1004. The physical traces therefore preferably include an electrically conductive material that is able to transfer information between the connector 1002 and bond region 1004. According to some approaches, the traces may be made from one or more electrically conductive metals, e.g., such as copper, silver, silicon, gold, aluminum, etc., and/or combinations thereof, e.g., such as alloys.

With continued reference to FIG. 10A, the connector 1002 is preferably configured to physically couple the traces to a controller. In other words, the connector 1002 is preferably configured to operatively couple the tape drive cable 1000 to a controller. For example, controller 215 of FIG. 2A is connected to tape head 211 via a cable 217. It follows that the connector 1002 in FIG. 10A may have a form factor that corresponds to a given type of connection, industry standards, the controller being connected to, programming language(s) implemented, the number of traces in the cable 1000, etc. Thus, the connector 1002 may desirably allow for the cable 1000 to be selectively electrically coupled to a controller (e.g., processor). In other words, the connector 1002 is also preferably configured to be attached and/or removed from controllers as desired during use.

In one example, the connector 1002 may include one or more tabs that are easily accessible to (and manipulatable by) a user, machine, etc., allowing for the cable 1000 to be attached and/or removed from controllers without using any specialty tools. In still other approaches, the connector 1002 may include one or more security features which prevent the cable 1000 from being removed from and/or attached to a controller without taking preliminary steps. For example, one or more locking mechanisms may be implemented in the connector 1002 to prevent unauthorized access to and/or removal from a controller, e.g., as would be appreciated by one skilled in the art after reading the present description.

The bond region 1004 is also preferably configured to enable physical coupling of the traces to electrical connections of a tape module. The bond region 1004 may function as an interface that operatively couples the traces in the read and write lines of the tape drive cable 1000, to various transducers on a magnetic tape head module. In one approach, the bond region 1004 may have electrical contacts that are electrically coupled to the module, e.g., via press fitting, adhesive with conductive particles therein, etc. In another approach, the bond region 1004 may have pads thereon that are coupled to the module via wire bonding. It follows that the configuration of the bond region 1004 may vary depending on the number of traces, the number of transducers on the magnetic tape head module, the spacing between the traces and/or transducers, mode of electrical coupling with the module, etc.

Referring momentarily now to FIG. 10B, a detailed view of the bond region 1004 and tape drive cable 1000 coupled to a magnetic tape head module 1006 is illustrated in accordance with one approach which is in no way intended to be limiting as mentioned above. Specifically, the bond region 1004 is shown as operatively coupling (e.g., physically connecting) each of the traces 1008 to at least a respective one of the electrical connections 1010. These electrical connections 1010 further extend to an array of magnetic read and write transducers (not shown). The electrical connections 1010 preferably include an electrically conductive material that is able to transfer information between the traces 1008 and the magnetic transducers. For example, the electrical connections 1010 may be made from one or more electrically conductive metals, e.g., such as copper, silver, silicon, gold, aluminum, etc., and/or combinations thereof, e.g., such as alloys. It is also preferred that each of the electrical connections corresponds to a unique transducer on the tape module. In other words, each trace and corresponding electrical connection is coupled to a respective transducer on the tape module.

Returning now to FIG. 10A, it follows that the tape drive cable 1000 is configured to transport information (e.g., data, instructions, results, etc.) between a controller operatively coupled to the connector 1002, and a plurality of magnetic transducers (e.g., write transducers, data read transducers, servo transducers, etc.) that are operatively coupled to the bond region 1004 by electrical connections (e.g., see electrical connections 1010 in FIG. 2B).

In addition to the tape drive cable 1000 and corresponding traces 1008, one or more Faraday cages preferably surround the write and/or read lines on all four sides of the respective traces. In other words, Faraday cages may include any desired type of conductive and/or magnetic materials that are configured to absorb EMI and other types of interference (e.g., RF). The Faraday cages may thereby be used to electrically shield each of the read and/or write lines from each other. This also desirably reduces the crosstalk that is experienced between traces 1008, particularly as spacing between the traces 1008 continues to shrink over time as magnetic tape heads increase the number of supported data channels.

As noted above, the continued miniaturization of magnetic head assemblies has contributed to crosstalk being experienced in conventional products. Crosstalk between the leads appears as noise in the readback signal, which adversely affects the critical signal to noise ratio, leading to limits in data rate, increased read error rate, etc. Crosstalk experienced in tape drive cables can be caused by space limitations in existing form factors that are confined by structural integrity. These in turn cause undesired transfer functions as well as read and/or write lines to be in close proximity. This can result in significant decreases to accuracy in determining position error signals, C1 values, signal to noise ratio (SNR) performance, etc. Moreover, as the number of supported data channels continues to increase, the read and write lines become further constrained by cable width restrictions. Conventional products have thereby been forced to balance functionality with poor performance and trace geometry. Again, a need exists for a configuration that can reliably eliminate the crosstalk observed in cables without sacrifice geometry or structural integrity.

In contrast to the shortcomings experienced by conventional products, approaches herein which implement read and/or write lines that have been surrounded by Faraday cages are able to significantly improve read and write performance. Again, this is true even as the spacing between adjacent traces 1008 shrinks to accommodate greater numbers of data channels.

For instance, looking now to FIG. 10C, a cross-sectional view of a portion of the tape drive cable 1000 of FIG. 10A is shown in accordance with one approach. The portion of the cable 1000 shown in FIG. 10C includes two read lines 1012 and a single write line 1014. However, this is in no way intended to be limiting. For instance, the tape drive cable 1000 may include any desired number of transducers spread across any desired number of read and/or write lines. In some approaches, the tape drive cable 1000 includes a sufficient number of traces in the read and write lines to support 32 different data channels. In other words, the tape drive cable 1000 may include a sufficient number of traces in the read and write lines to connect to 32 different transducers on a magnetic tape head module, thereby supporting 32 different data channels. In other approaches, the tape drive cable 1000 includes a sufficient number of traces in the read and write lines to support a magnetic tape head module having 64 different data channels. In still other approaches, the tape drive cable 1000 includes a sufficient number of traces in the read and write lines to support a magnetic tape head module having 128 different data channels.

The size (e.g., dimensions) of the traces 1008 and spacings therebetween may thereby vary depending on the approach. For example, the number of data channels that are supported may impact the dimensions of the traces 1008. Additionally, traces in read lines 1012 have different dimensions and configurations than traces in write line 1014. For instance, traces 1008 in write line 1014 are divided into corresponding pairs (e.g., see 1015), each pair including a first portion 1016 and respective second portion 1018. In some approaches, the first portions 1016 are supplied with a positive electrical charge, while the second portions 1018 are supplied with a negative electrical charge. In other approaches, the first portions 1016 are supplied with a negative electrical charge, while the second portions 1018 are supplied with a positive electrical charge. Each respective pair of write traces is thereby able to operatively control a corresponding transducer on a magnetic tape head module, e.g., as described above.

The width w1 of each of the first portions 1016 are preferably similar to each other (e.g., within a tolerance), while the width w2 of each of the second portions 1018 may also be similar to each other, respectively. However, the width w1 of each first portion 1016 is preferably less than the width w2 of each second portion 1018. According to different approaches, the width w1 of the first portion may be between about 5 μm and about 70 μm, more preferably between about 10 μm and about 50 μm, more preferably between about 20 μm and about 40 μm, still more preferably about 35 μm, but could be higher or lower depending on the desired approach. Moreover, the width w2 of the second portion may be between about 20 μm and about 100 μm, more preferably between about 30 μm and about 80 μm, more preferably between about 50 μm and about 70 μm, still more preferably about 65 μm, but could be higher or lower depending on the desired approach.

The distance separating immediately adjacent pairs of traces in the write line 1014 may also vary. In some approaches, the distance separating immediately adjacent pairs of traces in the write line 1014 is between about 50 μm and about 300 μm, still more preferably between about 100 μm and about 200 μm, but could be higher or lower depending on the desired approach. According to an illustrative approach, the distance d1 between the first portions 1016 in immediately adjacent corresponding pairs of write traces is between about 160 μm and about 170 μm, more preferably about 165 μm, but could be higher or lower depending on the approach. In another illustrative approach, the distance d2 between the second portions 1018 in immediately adjacent corresponding pairs of write traces may be between about 130 μm and about 140 μm, more preferably about 135 μm, but could be higher or lower depending on the approach.

The write line 1014 includes a pair of wider write traces 1019. The read lines 1012 also include a wider outermost trace 1021. Remaining “top” traces 1023 may have a width w3 of between about 10 μm and about 70 μm, more preferably between about 40 μm and about 60 μm, still more preferably about 50 μm, but could be higher or lower depending on the approach. The outermost trace 1021 may have a width w4 of between about 100 μm and about 200 μm, more preferably between about 120 μm and about 170 μm, still more preferably about 150 μm, but could be higher or lower depending on the approach. The spacing d3 between adjacent ones of the top traces 1023 may further be between about 10 μm and about 70 μm, more preferably between about 40 μm and about 60 μm, still more preferably about 50 μm, but could be higher or lower depending on the approach. The “bottom” traces 1025 may have a width w4 of between about 500 μm and about 1000 millimeters, more preferably between about 700 μm and about 800 μm, still more preferably about 750 μm, but could be higher or lower depending on the approach.

With continued reference to FIG. 10C, each of the read lines 1012 and the write line 1014 are surrounded by respective Faraday cages 1020, 1022. While only a cross-section of the Faraday cages 1020, 1022 are shown in FIG. 10C, it should be noted that the Faraday cages 1020, 1022 may extend any desired distance along the tape drive cable 1000. In preferred approaches, each of the Faraday cages 1020, 1022 extend from the bond region of the cable 1000 to the connector (e.g., see bond region 1004 and connector 1002 of FIG. 10A). This desirably provides crosstalk protection along the full lengths of the read and write traces. However, in some approaches a Faraday cage may be removed (e.g., absent) from a portion of the traces in the read and/or write lines.

As seen in the cross-sectional view of FIG. 10C, the Faraday cages 1020, 1022 surround each of the read and write lines 1012, 1014 on all four sides of the respective traces 1008 therein. In some approaches, a Faraday cage is embedded as a top layer, a bottom layer, and side layers. For instance, Faraday cage 1020 includes a “top” layer 1026, a “bottom” layer 1028, and “side” layers 1030. However, use of these relative terms are in no way intended to be limiting on how the cable 1000 as a whole is used and/or oriented. It should also be noted that while the Faraday cage 1020 layers 1026, 1028, 1030 are separated from the traces 1008, the Faraday cages may be formed as desired. For example, the “top” layer 1026 and/or “bottom” layer 1028 may be formed directly on the traces 1008 or respective outermost surfaces of the underlying cable 1000. Furthermore, “side” layers 1030 extend through the tape drive cable itself, thereby allowing the Faraday cage 1020 to maintain uniform sides that provide efficient shielding for each of the read and/or write lines using EMI.

In some approaches, the different layers of the Faraday cages 1020, 1022 are electrically connected together by a smaller conductor, e.g., such as a via, wire bond, etc. However, in another approach, the different layers of the Faraday cages 1020, 1022 are not electrically connected together in the cable (but may be effectively electrically coupled via a common ground).

In preferred approaches, the different layers of the Faraday cages 1020, 1022 are electrically coupled to a circuit ground, e.g., the ground of the electronics that reader and/or writer circuits in the bond region and/or on a magnetic tape head module are referenced to. In still other approaches, the different layers of the Faraday cages 1020, 1022 are floating and are not electrically coupled to ground. In further approaches, the different layers of the Faraday cages 1020, 1022 may be coupled to a predefined potential other than circuit ground.

In some approaches, one or more of the Faraday cages 1020, 1022 are built along with (e.g., in parallel with) the tape drive cable 1000. Thus, the tape drive cable 1000 may be formed around the respective Faraday cages 1020, 1022 and/or vice-versa. In other approaches, the Faraday cages 1020, 1022 may be added to an existing tape drive cable 1000. For instance, vias may be made in an existing tape drive cable to allow for the Faraday cages to be introduced. In still other approaches, the Faraday cages may be at least partially disassembled before being reconstructed (e.g., affixed) around an existing tape drive cable.

While various configurations, features and functions of the Faraday cages 1020, 1022 are provided in more detail below, in general, the Faraday cages 1020, 1022 help isolate the traces in each respective read and write line from each other. For instance, the Faraday cages 1020, 1022 may be constructed of any electrically conductive material that provides the desired functionality of reducing crosstalk between traces 1008. In general, materials having higher electrical conductivity are preferred in order to construct the Faraday cages 1020, 1022. Illustrative materials include copper, gold, etc. Alloys of metals, ceramics, etc. may also be employed in various approaches. Each of the Faraday cages 1020, 1022 preferably have a thickness “t” that is sufficient to provide at least a 50% reduction in detectable crosstalk between adjacent traces, and ideally at least an 80% reduction in detectable crosstalk, relative to an otherwise identical structure without the electrical shielding layer. For copper and/or gold, an illustrative thickness range may be between about 1 μm and about 20 μm thick, more preferably between about 5 μm and about 15 μm, but could be thicker or thinner depending on the desired approach. Moreover, one or more of the Faraday cages 1020, 1022 (and/or portions thereof) may be formed using plating, sputtering, etc., or any other processes that would be apparent to one skilled in the art after reading the present description.

The sides of the Faraday cages 1020, 1022 may also have different configurations depending on the approach. For instance, in some approaches, one or more of the surfaces of the Faraday cages 1020, 1022 may be a mesh of materials that together, form a surface that may be permeable to air, light, etc., but which is configured to absorb (e.g., block) EMI and other types of interference having specific wavelengths. In other words, the Faradays cages 1020, 1022 can have mesh-like holes that are smaller than the wavelength of a desired operating frequency, thereby effectively insulating the traces from any external noise. However, in other approaches one or more of the surfaces of the Faraday cages 1020, 1022 may be a combination of meshed and solid materials, thereby forming a Faraday “shield” around the read and/or write lines 1012, 1014, e.g., as would be appreciated by one skilled in the art after reading the present description.

It follows that the Faraday cages 1020, 1022 are desirably able to electrically shield each of the read and/or write lines 1012, 1014 from each other. This also desirably reduces the crosstalk that is experienced between traces 1008, particularly as spacing between the traces 1008 continues to shrink over time as magnetic tape heads increase the number of supported data channels. As noted above, the continued miniaturization of magnetic head assemblies has contributed to crosstalk being experienced in conventional products. Crosstalk between the leads appears as noise in the readback signal, which adversely affects the critical signal to noise ratio, leading to limits in data rate, increased read error rate, etc. In the case of the crosstalk between the writer and the servo reader lines, this cross-talk leads to a worse tracking capability preventing a reduction in the track density.

Looking now to FIGS. 10D-10E, Faraday cages having different configurations are shown as being implemented in combination with the tape drive cable 1000 of FIGS. 10A-10B. It follows that the present configurations of the Faraday cages may be implemented in conjunction with features from any other approach listed herein, such as those described with reference to the other FIGS. However, such Faraday cages and others presented herein may be used in various applications and/or in permutations which may or may not be specifically described in the illustrative approaches listed herein. Thus FIGS. 10D-10E (and the other FIGS.) may be deemed to include any possible permutation.

Looking first to FIG. 10D, the tape drive cable 1000 is shown as having a Faraday cage 1032 surrounding the first and second portions 1016, 1018 of traces 1008 in the write line 1014, while the read lines 1012 do not include Faraday cages, which is in no way intended to be limiting. In addition to having a “top” layer 1026, a “bottom” layer 1028, and “side” layers 1030, the Faraday cage 1032 includes a plurality of EMI shields 1036 that extend through the layers of the respective write line 1014. In other words, each of the EMI shields 1036 extend between immediately adjacent pairs of write traces and through the cable, e.g., as shown. More specifically, each of the EMI shields 1036 are shown as extending between the “top” layer 1026 and “bottom” layer 1028 of the Faraday cage 1032 and through the layers of the respective write line 1014, e.g., like the side layers 1030 of the Faraday cage 1032.

With proper grounding, the EMI shields 1036 will isolate the write signals in adjacent pairs of write traces, and stop the induction of voltage onto the neighboring traces. The EMI shields 1036 thereby prevent crosstalk between adjacent pairs of write traces by reducing and/or redirecting electromagnetic fields to protect against unwanted noise. Each of the EMI shields 1036 also preferably extends from the bond region of the cable 1000 to the connector, providing EMI protection along the whole length of the traces. In other words, each EMI shield 1036 may extend longitudinally along the length of the respective pair of immediately adjacent write traces. Each pair of write traces would thereby be fully encapsulated between: the top and bottom layers 1026, 1028 of the Faraday cage 1032; and adjacent ones of the EMI shields 1036.

In some approaches, one or more of the EMI shields 1036 include the same or similar materials as those used to form the Faraday cage 1032. However, one or more of the EMI shields 1036 include different materials as those used to form the Faraday cage 1032. Thus, depending on the approach, one or more of the EMI shields 1036 may include any desired type of conductive and/or magnetic materials that are configured to absorb EMI and other types of interference, thereby blocking crosstalk between adjacent traces. As noted above, these conductive and/or magnetic materials may be combined as a mesh of materials that together, form a surface that may be permeable to air, light, etc., but which is configured to absorb (e.g., block) EMI and other types of interference having specific wavelengths. However, in other approaches one or more of the EMI shields 1036 may be a combination of meshed and solid materials, thereby forming a Faraday “shield” between adjacent pairs of write traces, e.g., as would be appreciated by one skilled in the art after reading the present description.

Again, a Faraday cage 1032 combined with EMI shields 1036 are desirably able to electrically shield each of the read and/or write lines 1012, 1014 from each other, as well as adjacent pairs of traces in the write lines 1014. This desirably reduces the crosstalk that is experienced between traces, particularly as spacing between the traces continues to shrink over time as magnetic tape heads increase the number of supported data channels. As noted above, the continued miniaturization of magnetic head assemblies has contributed to crosstalk being experienced in conventional products.

Looking now to FIG. 10E, the tape drive cable 1000 is shown as having a Faraday cage 1042 that surrounds the first and second portions 1016, 1018 of traces 1008 in the write line 1014. Additionally, Faraday cages 1044 also surround the various traces 1008 in each of the respective read lines 1012. However, this is in no way intended to be limiting, and in other approaches one or more of the read lines 1012 (and/or those not shown in FIG. 10E) may not include a Faraday cage at all.

Looking to the Faraday cage 1042 that surrounds the write line 1014, a plurality of EMI shields 1036 are also shown as extend through the layers of the respective write line 1014. In other words, each of the EMI shields 1036 extend between immediately adjacent pairs of write traces and through the cable, e.g., as shown. More specifically, each of the EMI shields 1036 are shown as extending between the “top” layer 1026 and “bottom” layer 1028 of the Faraday cage 1042 and through the layers of the respective write line 1014, e.g., like the side layers 1030 of the Faraday cage 1042. The EMI shields 1036 thereby prevent crosstalk between adjacent pairs of write traces by reducing and/or redirecting electromagnetic fields to protect against unwanted noise.

Additionally, an EMI layer 1046 is positioned between the traces in each respective pair 1015. The EMI layer 1046 preferably runs about perpendicular to each of the EMI shields 1036, e.g., as shown in the cross-sectional view of FIG. 10E. In other words, each of the EMI shields 1036 extend along a respective EMI shield plane, and the EMI layer 1046 extends along a plane that is about perpendicular to each of the EMI shield planes taken along a cross-section of the respective Faraday cage.

The EMI shields 1036 and EMI layer 1046 thereby prevent crosstalk between each of the various write traces. The EMI shields 1036 and EMI layer 1046 also preferably extend from the bond region of the cable 1000 to the connector, providing EMI protection along the whole length of the traces. In other words, each EMI shield 1036 and the EMI layer 1046 may extend longitudinally along the length of the write traces. Each individual write trace would thereby be fully encapsulated between: the top or bottom layers 1026, 1028 of the Faraday cage 1042; the EMI layer 1046; and adjacent ones of the EMI shields 1036.

In still further approaches, Faraday cages may be used to surround each of the read lines in a cable, while the write lines in the cable are not surrounded by Faraday cages (not shown). It follows that any desired configuration (e.g., combination) of the various Faraday cages, EMI shields, EMI layers, etc. may be implemented.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A tape drive cable, comprising:
a connector;
a bond region;
read and write lines that that include traces and that extend from the bond region to the connector; and
at least one Faraday cage that surrounds the write and/or read lines on all four sides of the respective traces.

2. The tape drive cable of claim 1, wherein the connector is configured to physically couple the traces to a controller.

3. The tape drive cable of claim 1, wherein the bond region is configured to enable physical coupling of the traces to electrical connections of a tape module.

4. The tape drive cable of claim 3, wherein each of the electrical connections corresponds to a transducer on the tape module.

5. The tape drive cable of claim 1, wherein the Faraday cage is embedded as a top layer, a bottom layer, and side layers that extends through layers of the tape drive cable.

6. The tape drive cable of claim 1, wherein the at least one Faraday cage includes Faraday cages that surround each of the respective write and read lines on all four sides of the respective traces.

7. The tape drive cable of claim 1, wherein the at least one Faraday cage includes: Faraday cages that surround each of the respective write lines on all four sides of the respective traces.

8. The tape drive cable of claim 7, wherein each Faraday cage includes a plurality of electromagnetic interference (EMI) shields extending through layers of the respective write line, wherein each of the EMI shields extends between adjacent pairs of write traces.

9. The tape drive cable of claim 8, wherein adjacent pairs of write traces are between about 100 microns and about 200 microns.

10. The tape drive cable of claim 9, wherein each pair of write traces includes a first portion and a second portion, wherein the first portion has a width of between about 10 microns and about 50 microns, wherein the second portion has a width of between about 30 microns and about 80 microns.

11. The tape drive cable of claim 7, wherein each Faraday cage includes an EMI layer positioned between the write traces in each respective pair.

12. The tape drive cable of claim 11, wherein each of the EMI shields extends along a respective EMI shield plane, wherein the EMI layer extends along a plane that is perpendicular to each of the EMI shield planes taken along a cross-section of the respective Faraday cage.

13. The tape drive cable of claim 1, wherein the read and write lines form an array having at least 32 different channels.

14. The tape drive cable of claim 1, wherein the read and write lines form an array having at least 64 different channels.

15. The tape drive cable of claim 1, wherein the read and write lines form an array having at least 128 different channels.

16. A tape drive cable, comprising:
a connector;
a bond region;
read and write lines that that include traces and that extend from the bond region to the connector; and
Faraday cages that surround each of the write lines on all four sides of the respective traces.

17. The tape drive cable of claim 16, wherein each Faraday cage includes a plurality of electromagnetic interference (EMI) shields extending through the layers of the respective write line, wherein each of the EMI shields extends between adjacent pairs of write traces.

18. The tape drive cable of claim 16, wherein each Faraday cage includes an EMI layer positioned between the write traces in each respective pair, wherein each of the EMI shields extends along a respective plane, wherein the EMI layer extends along a plane that is perpendicular to each of the EMI shield planes taken along a cross-section of the respective Faraday cage.

19. The tape drive cable of claim 16, wherein the read and write lines form an array having at least 64 different channels.

20. The tape drive cable of claim 16, wherein the read and write lines form an array having at least 128 different channels.
